(19) United States
(12) Patent Application Publication
(10) Pub. No.: US 2007/0052529 A1
(43) Pub. Date: Mar. 8, 2007

(54) Motor vehicle dual alarm system kit for child seats

(76) Inventor: Signifredo C. Perez, Waterford, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/209,503

(22) Filed: Aug. 23, 2005

(51) Int. Cl. B60Q 1/00

(52) U.S. Cl. 340/457

(57) ABSTRACT

An alarm system incorporated into a motor vehicle for warning of an unattended condition associated with an occupant left within the vehicle. The vehicle includes a first seating location and a second seating location. The alarm system includes a first, mat shaped and pressure activated sensor associated with the first seating location and a second corresponding sensor associated with the second seating location. A wire harness communicates with each of the first and second sensors. A processor driven and control relay operatively communicates with the sensors, via the wire harness, the relay, upon determining a first sensor condition associated with a first unoccupied seating location concurrent with determining a second occupied seating location, activates an audible alarm associated with the vehicle. A presetting driver's seat sensor may also be employed to activate the alarm, in the instance of the driver switching off the alarm and, failing to do so, causing a control thermostat to activate the alarm upon an internal vehicle temperature reaching a determined upper or lower threshold.

### BACKGROUND OF THE INVENTION

1. Field of the Invention

The present invention relates generally to vehicle alarm systems associated with child seat devices. More specifically, the present invention teaches a motor vehicle dual alarm system kit for a child seat, and which alarms a vehicle driver of a child's presence in the child car seat, preventing a child from being left in the child car seat, upon the driver vacating the driver's seat. The driver may switch the alarm to off automatically, presetting the driver's seat sensor to activate the alarm when the driver's seat is occupied, reminding the driver to switch back to the child seat sensor. If the driver fails to do so, a control thermostat will activate the alarm when the temperature in the vehicle reaches a predetermined degree. The control thermostat will only take over the alarm function if the driver positions the button switch to the child seat sensor activating alarm, pushes the button switch 11A to stop the alarm, walks away for something, and forgets the child in car. The control thermostat will activate the alarm when a temperature in the vehicle reaches a predetermined degree level designated as being too hot or too cold. Therefore, detecting child presence, driver absence and maximum temperature are features associated with the alarm system of the present invention.

2. Description of the Prior Art

The use of alerting devices is known in the prior art. More specifically, alerting devices heretofore have been utilized for the purpose of notifying operators/occupants of a vehicle of either the presence of or absence of a child or toddler, such as in relation to a child seat assembly.

U.S. Pat. No. 6,819,249, issued to Papp, teaches a child detection system incorporating a plurality of pressure sensors, each removably positioned selectively under one or both of the front and rear seat areas such that pressure on one of the seat areas actuates an associated one of the pressure sensors. A control is electrically coupled to an electrical power supply and is electrically coupled to each of the pressure sensors. The control is selectively coupled to the electrical system of the vehicle such that the processor may detect when the vehicle is turned off. An alarm is operationally coupled to the control and emits an audible sound when any of the pressure sensors sense pressure. The control is turned on when the vehicle is turned off.

U.S. Pat. No. 6,535,137, issued to Ryan, teaches a child seat alarm including a car seat portion adapted for being positioned within a motor vehicle. The car seat portion includes child engagement straps. The child engagement straps include a male buckle and a corresponding female receptacle. The male buckle is lockingly received within the female receptacle in a locked position. An alarm is disposed within the car seat portion. The alarm includes a pair of speakers for broadcasting an audible alarm. The alarm is in an activated orientation when the male buckle is lockably received within the female receptacle. The alarm is in a deactivated orientation when the male buckle is removed from the female receptacle. The alarm is in communication with an electrical system of the vehicle whereby a shutdown of the motor vehicle's engine or an opening of the driver's door will sound the alarm when the alarm is in the activated orientation.

U.S. Pat. Nos. 6,104,293 and 5,949,340, both issued to Rossi, teach a warning apparatus for when a child is left in an infant seat and a vehicle ignition disengaged. The apparatus includes an occupant detection mechanism for detecting the presence of an occupant (infant) within the infant seat. An ignition detection mechanism detects the state of the vehicle's ignition system. A control unit generates an alarm signal when the occupant detection mechanism detects the presence of an occupant within the infant seat and the ignition detection system has been turned off. At that point, alarm units generate an alarm in response to the alarm signal. The components of the apparatus can be located within the infant seat and/or within the vehicle.

U.S. Patent Application Publication No. 2004/0239183, to Delgado et al., teaches a child safety system for a motor vehicle in which the driver door switch is electrically connected to the vehicle battery in order to activate the vehicle interior lighting system when the door is closed. A child safety seat is provided with an electrical circuit including a pressure sensitive switch with an alarm and a circuit with a connector for connection to the door switch circuit.

The electrical circuit associated with the child safety seat is activated by the weight of the child applied onto the pressure sensitive switch when the child is placed in the seat. Upon plugging the seat into the driver side door circuit, the alarm is activated upon the driver side door being opened, with the child present in the safety seat. In this manner, when a child is not strapped into the seat, the child safety seat can either remain unplugged on the rear seat of the vehicle or plugged into the door circuit, and the electrical circuit and alarm will be disconnected from the door circuit.

Finally, U.S. Pat. No. 5,793,291, issued to Thornton, teaches a child alert system for automobiles and which detects the presence of a person locked in a parked automobile. The alarm system includes a motion detector and a temperature detecting element coupled to a NOR gate. The motion detector transmits a low signal to the NOR gate once it detects motion within the interior of the automobile. The temperature detecting element transmits a low signal to the NOR gate if the temperature in the vehicle exceeds a predetermined extreme temperature. The NOR gate, upon receiving low signals from both the temperature detecting element and the motion detector, transmits an alarm signal.

### SUMMARY OF THE INVENTION

The present invention discloses a dual alarm system kit incorporated into a vehicle and for alarming a designated driver of a child's presence within a child car seat in a motor vehicle, and in particular when a driver's seat is vacated or not occupied. Additionally, the system possesses dual capabilities for being manually switched to sense a driver presence or absence. When the alarm is intentionally switched off, a control thermostat will activate the alarm when a vehicle interior temperature reaches a preset temperature range.

As is known, the vehicle includes a front seat area, a rear seat area, an interior and an existing electrical system. The alarm dual system kit comprises a plurality of cushion pressure sensors mats, positioned both upon the driver's front seat area, as well as within at least one child car seat seating (cavity) area, such that pressure exerted upon any of the seating areas actuates the associated pressure sensors.

A control relay is selectively coupled to the vehicle's electric system such that the control relay may activate or deactivate the alarm system, depending upon the actuated state of each of the two pressure sensors. A pushbutton switch allows the driver to select alarm priorities between both sensors, and further in which the child seat sensor is also coupled to a control thermostat.

An alarm buzzer is operationally coupled to the control relay, as well as to the cushion pressure sensor mat. The buzzer emits an audible sound upon the driver vacating the driver's seat, combined with the cushion pressure sensor mat within the child seat cavity detecting the continued presence of a child. A pushbutton switch allows the driver to deactivate the alarm by reversing the sensor to detect priority from the child seat sensor to the driver seat sensor. Therefore, the alarm will activate when the driver occupies the driver's seat, reminding the driver to switch priority back to the child seat sensor, otherwise the alarm will activate when driver vacates the driver's seat.

A control thermostat is coupled to the child seat sensor and a pushbutton switch will override the driver seat sensor if a temperature reaches a preset range (hot/cold temperature level). The temperature control sensor will open a ground continuity from the child seat sensor to a pushbutton switch to the second alarm buzzer 88, upon the driver sensor indicating that the seat is not occupied. (This is the only condition the temperature control sensor will take action.) The alarm buzzer and the control relay are both coupled to a plastic box and fastened such as underneath the instrument panel or under the driver's seat. The pushbutton switch is preassembled to a mounting bracket so as to be installed under or to a plastic box within the reach of the operator. The thermostat can be installed within the plastic box, over the dashboard, or under the seat to compute the desired objective.

### BRIEF DESCRIPTION OF THE DRAWING

Reference will now be made to the attached drawings, when read in combination with the following detailed description, wherein like reference numerals refer to like parts throughout the several views, and in which:

FIG. 1 is a plan view of the motor vehicle alarm system kit according to a preferred embodiment of the present invention;

FIG. 2 is a schematic diagram of the alarm system incorporated into the invention of FIG. 1;

FIG. 3 is a further schematic diagram view illustrating a compressed child seat cushion pressure sensor mat activating the alarm system;

FIG. 4 is a yet further schematic diagram view illustrating a child's weight compressing and activating the child seat cushion pressure sensor mat, in cooperation with weight on the driver's seat cushion pressure sensor mat acting to disable the alarm system;

FIG. 5 is another schematic diagram view of the present invention, illustrating a condition by which a driver manually deactivates an alarm by button switch action and pre-arming of a second alarm buzzer;

FIG. 6 is a further rendition of FIG. 5, illustrating a deactivated child seat alarm 8 and wherein a control thermostat reaches its set point activating a backup alarm buzzer with a driver sensor indicating a vacant condition; and

FIGS. 7(a)-7(j) illustrate respective alarm kit components incorporated into the present invention.

### DESCRIPTION OF THE PREFERRED EMBODIMENT

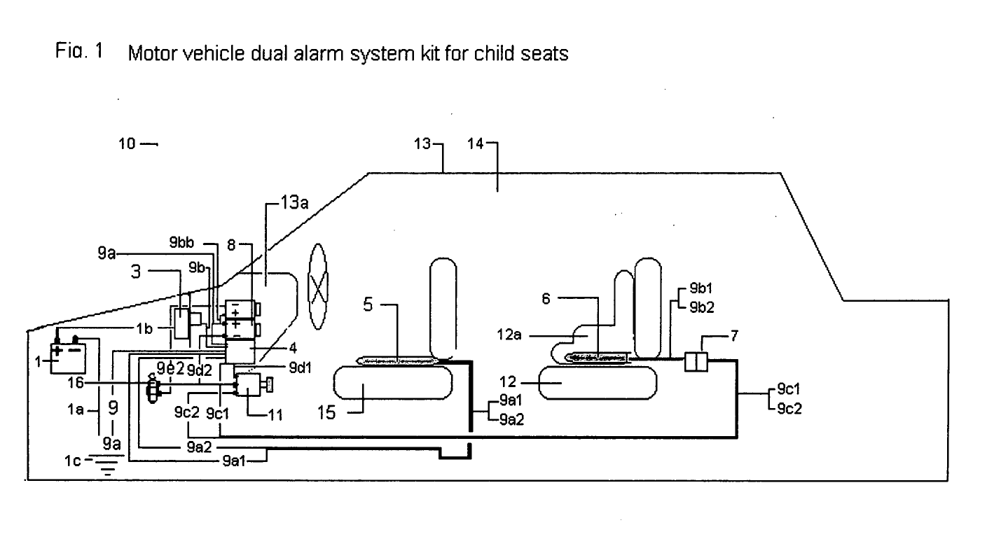

Referring now to FIG. 1, a motor vehicle cushion pressure sensor mat dual alarm system kit is illustrated at 10 embodying the principles and concepts of the present invention. Specifically, and as will be hereinafter described, the present system discloses a motor vehicle dual cushion pressure sensor mat dual alarm system kit for a child seat, and specifically operatively communicating with a further pressure sensor incorporated into the vehicle operator's seat and for preventing an assigned driver from exiting a vehicle while leaving a child inside the motor vehicle, and once the driver vacates the driver's seat. The driver can also press a button switch to shut off the alarm. The alarm reverses function and activates when the driver again occupies the driver's seat. The driver may further use the button switch to reset the child seat alarm.

As will be subsequently described, a first seat sensor is installed within a driver's seat, in combination with a further child car seat cushion pressure sensor mat and all its system components hard wired to the motor vehicle. The kit assembly of the present invention contemplates the provision of at least two separate cushion pressure sensors mats. It is also envisioned that further pluralities of cushion sensor mats can be incorporated, such as including a further child sensor mat in the instance of more than one child being transported within the vehicle, as well as full seat cushions for older children, floor mat mounted sensors, as well as sensors located in rear trunk or cargo spaces in vans and school buses.

Preferred materials incorporated into the sensor mat sheets include flexible conductive thin sheets of aluminum, conductive fabrics, conductive plastics and, in one preferred embodiment, sheets of aluminum screen material. The preferred non-conductive material used to separate both conductive plates include foam sheets, which are internally hollowed to allow contact between both conductive sheets. The assembly may further include plastic spacers and, in one further preferred variant, the hollowed out interior of the non-conductive sheet can include a rubber coating.

Preferred materials used to cover and surround the conductive plates include foam sheets, plastic sheets, or, in one preferred variant, a rubber coated flexible material. An encasing outer material for the pressure sensor mats includes such as leather, plastic, vinyl or cloth materials.

It is further contemplated that the size and shape of the driver's sensor mat is such that it will comfortably fit within the seating radius of the driver. The size and shape of the child seat sensor mat is likewise contemplated to be sized so that it is shaped to fit comfortably within the cavity of the child's seat, such as specifically a strapped-in car seat, but also contemplated to include a suitable child pressure sensor mat which could be incorporated directly upon an existing (rear) seat surface of a vehicle.

As will be referenced in the succeeding discussion of the several drawing illustrations, the present kit assembly further includes a control relay, an alarm buzzer, a plastic box to secure both the control relay and alarm buzzer, a fuse box circuit electrical adapter, and an electrical body harness with a quick release connector to allow removal of the child cushion pressure sensor mat along with the child car seat. It is also contemplated in the present assembly to include a driver seat sensor quick connect (not shown in FIGS. 1-7).

The present assembly includes a pushbutton double pole switch to deactivate the alarm manually. The purpose for this is to allow the vehicle operator a brief respite, such as to intentionally exit and re-enter the vehicle without having to remove the child from the safety seat and/or disengage the pressure mat harness system. The alarm reactivates when the driver's weight is sensed the moment the driver's seat is occupied. The action of the driver shutting off the alarm rearms the child seat sensor alarm, and will set off the alarm upon the driver exiting the vehicle. Such components are individually configured and correlated with respect to each other and hard wired to the motor vehicles electrical system so as to attain the desired objective.

Referring now specifically to the drawings, FIG. 1 illustrates a motor vehicle dual cushion pressure dual alarm system kit 10 for a child car seat 12a in a system for detecting and alarming the driver, when vacating a driver's seat 15, of the continued presence of a child in a vehicle 13. The vehicle 13 is conventionally known and includes a front seat area 15 and a rear seat area 12 set within an overall interior 14.

The vehicle 13 further includes a battery 1 having a positive 1b connection to a vehicle fuse box 2, as well as a negative ground connection 1a to a chassis ground 1c. The child or infant seat 12a is adapted to be fastened into place within the vehicle 13, such as upon the rear seat 12 in a conventional manner and such as using a seat belt associated with the vehicle 13.

In a further variant, the infant/child seat 12a may include a base unit that remains within the vehicle 13, in addition to a seat unit that attaches to the base unit in a conventional manner. Still further, the infant or child seat 12a may be of the type that is built/incorporated directly into the vehicle 13.

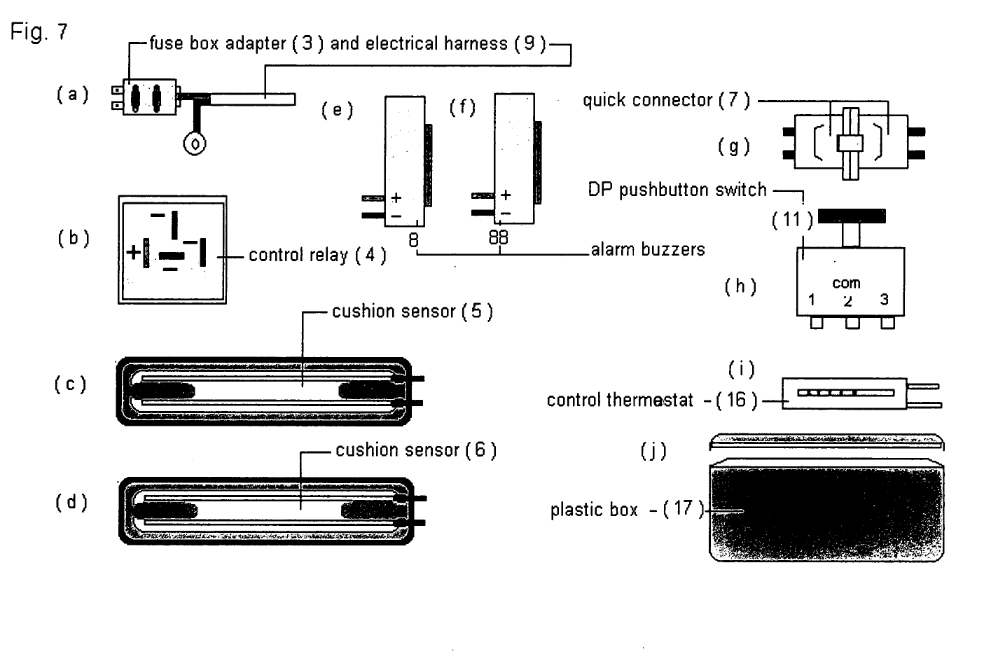

As further has been previously described, the motor vehicle dual cushion mat pressure sensor dual alarm system kit 10 includes two separate cushion mat pressure sensors. A first mat sensor 5 (see FIG. 7c) is placed over the seating surface of the front/driver's seat 15, in cooperation with a second cushion mat sensor 6 (see also FIG. 7d) placed within the cavity of child seat 12a (again set upon the rear seat 12 of the vehicle).

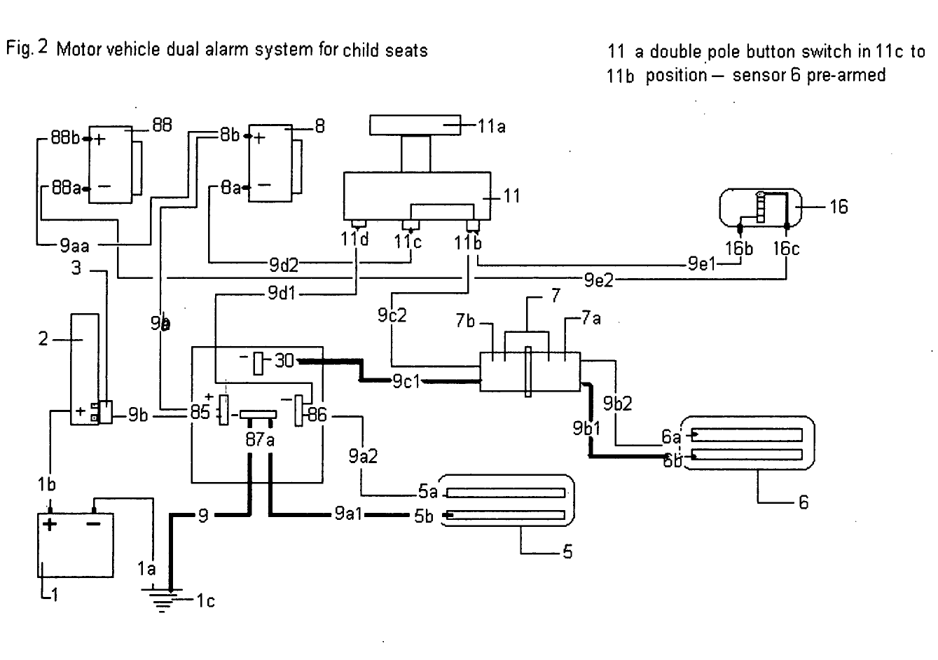

As is also illustrated throughout the schematic illustrations of FIGS. 2-6, a two wire harness 9 includes positive wire 9b coupled to fuse box adapter 3 (see also FIG. 7a), and which is inserted into the electrical positive circuit slot of the vehicle fuse box 2. Alternatively, the harness can also be coupled to any live positive wire extending within vehicle 13.

A ground wire 9a, also associated with the harness 9, is coupled to a chassis ground 1c. Alternatively, the ground wire 9a can also be coupled to any ground location within the vehicle 13. The positive wire 9b is respectively coupled to a terminal 85 of the control relay 4 (see again FIGS. 2-6). The ground wire 9BB couples from terminal 85 to terminal 8B of alarm 8. Terminal 8B of the alarm 8 couples to positive wire 9AA, which couples to terminal 88B of backup alarm buzzer 88. It is further noted that references such as “hard wired” will be made to address this point as each step is described in FIGS. 2-6.

Positive wire 9BB is respectively coupled from terminal 85 to an alarm buzzer terminal 8b. Positive wire 9AA couples from terminal 8B to terminal 88 of the buzzer 8. The control relay 4 (also FIG. 7b) and alarm buzzer 8 can be fastened to a plastic box 17 (see FIG. 7j) with known fasteners (not shown) or, alternatively, may be fastened under the driver's seat 15, under the I.P. dashboard 13a, or anywhere in or on the motor vehicle 13. The pushbutton switch may be prefastened onto a bracket to be fastened under the I.P. dashboard 13A or to the plastic box 16 with known fasteners.

The cushion sensor mat 5 includes a component 5b, connected to a negative wire 9a1, this respectively coupled to terminal 87a of control relay 4. The cushion sensor mat 5, with component 5a thereof, is connected to a wire harness 9a2, this further connected to a terminal 86 of the control relay 4. The cushion sensor mat 6 includes conductive sheet 6b connected to a negative wire 9b1, this respectively coupled to a quick connect female end 7a which interlocks with a further quick connect male end 7b associated with a quick change connector 7. The same quick change process can also be adapted to the driver sensor 5.)

A wire harness 9c1 is respectively coupled to a control relay terminal 30 of the control relay 4. The cushion sensor mat 6 includes a conductive sheet 6a connected to a negative wire 9b2, respectively coupled to the quick connect female end 7a and which interlocks with the quick change male end 7b of the quick change connector 7 (see harness quick connect shown in FIG. 7g). A wire harness 9c2 is respectively coupled to the negative terminal 11B of double pole button switch 11 which can be switched by button 11A to feed continuity from 11B to 11C through negative wire 9d2 connected to terminal 8A of the alarm buzzer 8.

Referring now again to FIG. 2, a schematic diagrammatic view is shown of the present invention 10, and which is illustrative of an electrical condition corresponding to an empty parked motor vehicle 13 (see again FIG. 1). In this condition, and electrically hard wired up to the control relay 4, as discussed in FIG. 1, the positive terminal 85 is in a normally open position, allowing a ground condition between terminal 87a and the terminal 30. The terminal 87a opens ground to the conductive sheet 5b, associated with sensor mat 5, and the terminal 30 opens ground to the conductive sheet 6b of the sensor mat 6.

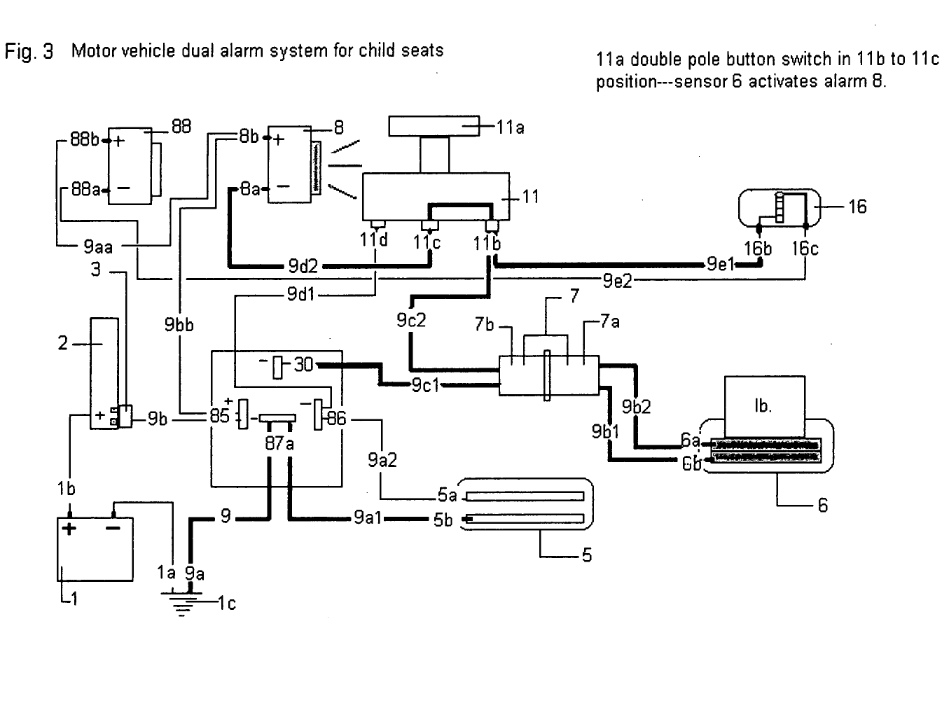

As now shown in FIG. 3, a schematic diagram view is illustrated of the present invention 10 with the alarm system buzzer 8 activated while motor vehicle 13 is parked. Electrically hard wired to the control relay 4, as discussed in FIG. 1, the positive terminal 85 is in a normally open position, thus allowing a ground connection between the terminal 87a and the terminal 30, sending ground to the conductive sheet 6b of the sensor mat 6.

In operation, the button switch 11A of switch 11 must be in the 11C to 11B position to arm sensor 6. The child seat cushion sensor mat 6 is weighed down (by virtue of the downward applied weight of the child) closing the gap between the conductive sheets 6a and 6b, and which, on contact, allows ground continuity through DP switch 11, preposition terminal 11B, to terminal 11C to the alarm buzzer terminal 8a, thereby activating the alarm buzzer 8. Furthermore, terminal 11B pre-arms terminal 16B of control thermostat 16, as backup for alarm 88.

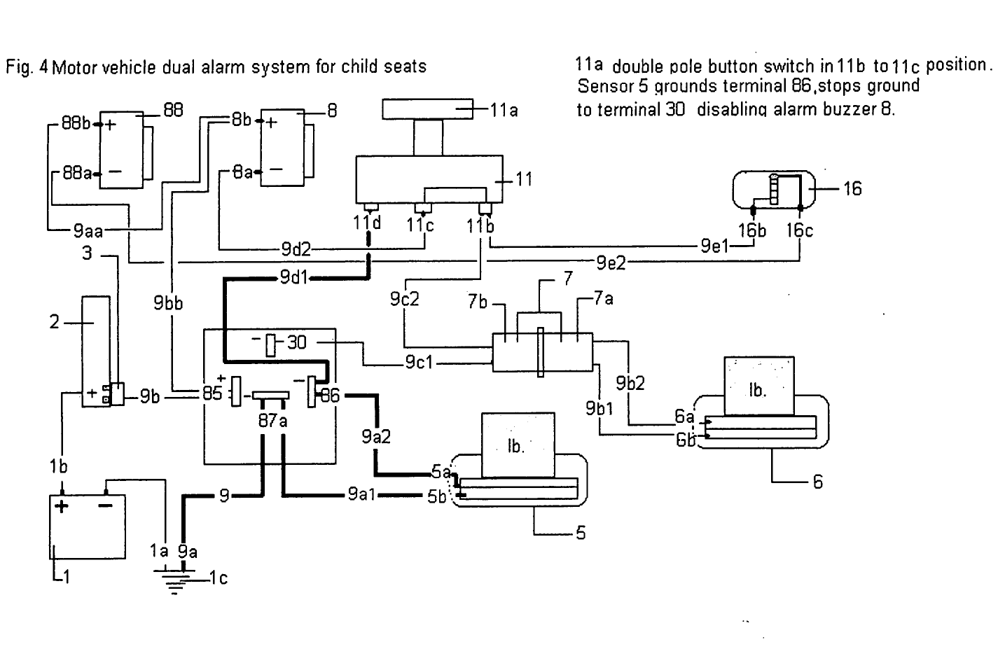

Referring now to FIG. 4, illustrated is a schematic diagram view of a further electrical condition associated with the present invention 10, and by which being electrically hard wired to the control relay 4, as discussed in FIG. 1, the conductive sheet 5a is weighed down to contact the conductive sheet 5b of the sensor mat 5. The control relay 4 terminal 86 in this illustration is grounded to a closed position, switching off the ground between terminal 87a and the terminal 30 of the control relay 4, thereby disrupting ground to the sensor mat 6 to disable alarm system buzzer 8 and backup buzzer 88. Terminal 86 of the control relay 4 grounds to terminal 1d of DP button switch 11.

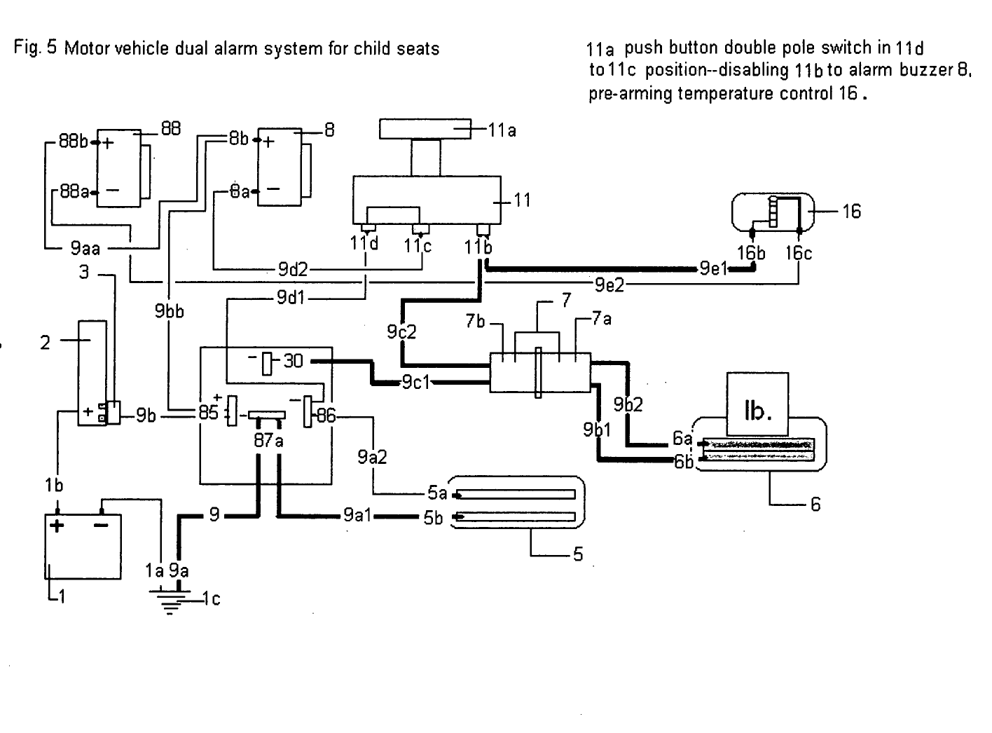

FIG. 5 now illustrates a schematic diagram view of the present invention 10, electronically hard wired to the control relay 4, as discussed in FIG. 1, and wherein the double pole pushbutton switch 11 has a pushbutton 11A positioned in 11d terminal to 11c terminal position, disabling alarm activation. Terminal 11B couples to terminal 16B, pre-arming terminal 16B of control thermostatic 16.

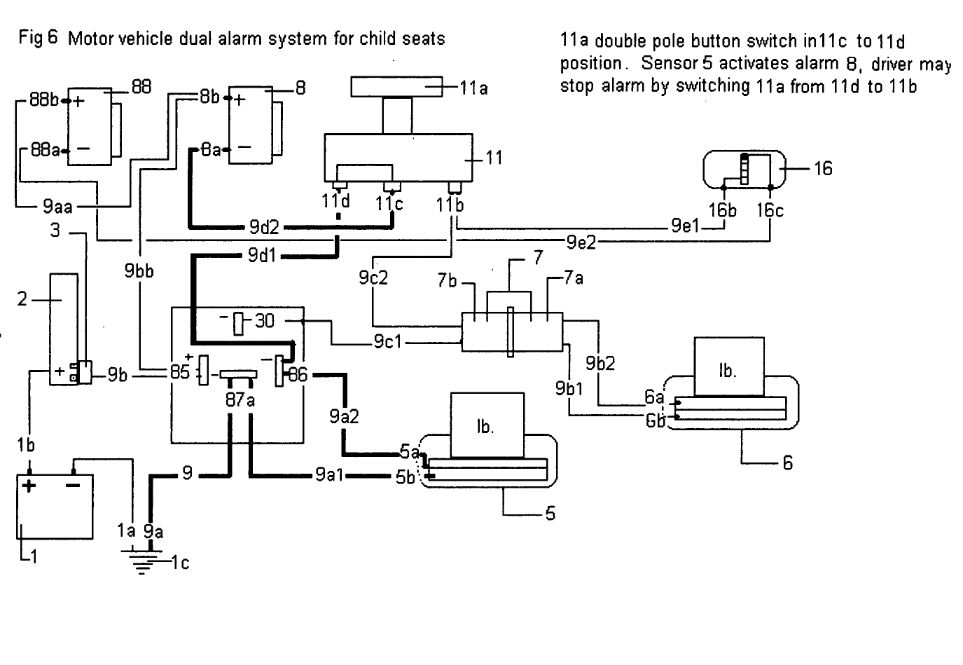

FIG. 6 further illustrates FIG. 5 pushbutton 11A disabling terminal 11B to alarm buzzer 8 and pre-arming control thermostat 16. Once an interior cabin temperature reaches preset temperature, control thermostat 16 opens ground terminal 16C through 9EZ to terminal 88A and activates the alarm buzzer 88.

In view of the foregoing, the present invention provides an improved motor vehicle dual alarm system kit for a child car seat not shown or described by the prior art. Additional advantages achieved by the present invention include the ability of the kit assembly to not depend upon ignition on/off positions, doors opening, shift lever positions, strap engagements, or scanning sensors.

Additional advantages include the ability of the present assembly to utilize the existing electrical system associated with the vehicle. The wiring harness so provided allows electrical connections between all required and sequenced components, including a quick connector allowing the child car seat sensor to be removed along with the seat. The harness is further coupled to the plurality of cushion pressure sensor mats, a control thermostat and to the control relay, and a double pole button switch which provides for activation or deactivation of the child car seat alarm system and/or driver's seat alarm system.

The present invention further provides a kit assembly for either retrofit or initial manufactured installation of an alarm system and which is adaptable to any motor vehicle having front and rear seating areas requiring one positive and one negative electrical connection. This system can be integrated to the ECM and also the ECM of future vehicles. Plus, this system can also be integrated for use with global positioning systems.

It is also envisioned that the use of a substitute timer for the control thermostat previously described can be accomplished according to the dual alarm function. The present alarm system can also be incorporated into a vehicle's electrical control module or body control module.

It is also envisioned that, aside from the seat-mounted sensors described, other applications include floor mats, rear SUV cargo area sensor mats, as well as again front and rear seat cushion mats for other occupants. Other applications include the usage of laser presence detectors, movement detectors, and weight sensors integrated within the front and rear seats of the vehicle.

Having described my invention, other and additional preferred embodiments will become apparent to those skilled in the art to which it pertains, and without deviating from the scope of the appended claims:

I claim:

1. An alarm system incorporated into a motor vehicle for warning of an unattended condition associated with an occupant left within the vehicle, the vehicle including a first seating location and a second seating location, said alarm system comprising:
a first sensor associated with the first seating location;
a second sensor associated with the second seating location;
a wire harness communicating with each of said first and second sensors;
a processor driven and control relay operatively communicating with said sensors, via said wire harness, said relay, upon determining a first sensor condition associated with a first unoccupied seating location concurrent with determining a second occupied seating location, activating an audible alarm associated with the vehicle.

2. The system as described in claim 1, each of said sensors further comprising a pressure sensor mat, a first of said sensor mats disposed upon a seating surface associated with a child car seat, a second of said sensor mats disposed on the seating surface of a driver's seat.

3. The system as described in claim 1, said control relay further comprising a first terminal including a first set of contacts, said first set of contacts in a normally open position being coupled to a fuse adapter positive terminal, said relay further including a first terminal of a second set of contacts, said second set of contacts in a normally open position connected to an electrical ground of the vehicle.

4. The system as described in claim 3, said wire harness further comprising:
a first terminal coupled to a positive terminal of a fuse adapter associated with a positive terminal of said audible alarm, said fuse adapter being respectively coupled to the vehicle's fuse box, a second electrical terminal being coupled to a ground of the vehicle, said electrical harness further being operationally coupled to said alarm buzzer, said control relay, a DP switch, said child seat sensor mat, and said driver's seat sensor mat responsive to said alarm signal.

5. The system as described in claim 4, the vehicle additionally including an electrical system, an engine, a front seat area, a rear seat area, an interior, a battery having a positive and a negative terminal, the negative terminal being coupled to ground and the positive terminal coupled to the fuse box of the vehicle.

6. The system as described in claim 5, said wire harness having a first terminal coupled to a positive terminal of a fuse adapter, said fuse adapter being respectively coupled to the vehicle's fuse box and coupled to said positive terminal of alarm buzzer, said second electrical terminal being coupled to an electrical ground of the vehicle.

7. The system as described in claim 6, said first and second sensors further comprising pressure sensor mats for detecting the presence or absence of an occupant at each of the first and second seating locations, each of said cushion pressure sensor mats being coupled to said relay contacts in a normally open position, as well as connected to said ground, activation/deactivation of said alarm being dependant upon presence or absence of an occupant on the surface of each said cushion pressure sensor mats.

8. The system as described in claim 7, further comprising a plurality of pressure sensor mats, a first of said mats being configured in design to fit over a driver's seat, said second mat being configured in design to fit within a child seat cavity.

9. The system as described in claim 8, wherein said first sensor mat can be configured to fit in a concealed position within a cushion of the driver's seat, wherein said second sensor mat can be configured to fit within a child seat cavity.

10. The system as described in claim 8, each of said pressure sensor mats further comprising:
a pair of conductive sheets, separated by a hollowed, compressible and non-conductive cushion material, electrical contact between said conductive sheets occurring upon the application of downward pressure; and
said plurality of conductive sheets each further having a bottom surface and a top surface covered with a solid non-conductive sheet of cushion material and encased in a covering fabric.

11. A motor vehicle dual pressure sensor mat alarm system kit, for sensing and generating an alarm signal alerting a designated driver of a child's presence in a child seat when vacating the driver's seat according comprising, in combination:
a plurality of pressure sensor mats, a first sensor mat disposed on a seating surface of a child car seat and a second sensor mat disposing on the seating surface of a driver's seat;
a control relay having a first terminal of a set of contacts, said first set of contacts in a normally open position coupled to a fuse adapter associated with a vehicle, and a first terminal of a second set of contacts, said second set of contacts being in a normally open position connected to an electrical ground of the vehicle;
an electrical harness having a first terminal coupled to a positive terminal of said fuse adapter, said fuse adapter being respectively coupled to the vehicle's fuse box and the second electrical terminal being coupled to the ground of the vehicle; and
an alarm buzzer operationally coupled to said control relay, DP switch and, upon determining a first sensor condition associated with a first unoccupied seating location concurrent with determining a second occupied seating location, activating an audible alarm associated with the vehicle.

12. The motor vehicle dual pressure sensor mat alarm system kit, as described in claim 10, wherein an entire alarm system assembly and components is preassembled, requiring only two electrical connections, wherein said electrical harness couples to a chassis ground and said fuse adapter inserts into said fuse box; wherein further said control relay and said alarm buzzer are prefastened to said plastic box with known fasteners.

13. The motor vehicle dual pressure sensor mat alarm system kit as described in claim 12, wherein said mounting plastic box and said DP switch are disposed and fastened, with a known fastener, at a given location including at least one of under the instrument panel and under the driver's seat of the vehicle.

14. The motor vehicle dual pressure sensor mat dual alarm system kit in accordance with claim 11, wherein said electrical harness is of sufficient length to reach from a vehicle instrument panel, beneath an under front carpet and driver's seat to connect to said alarm buzzer and said control relay, said harness extending further to first said sensor mat, under a rear carpet and rear seat and extending upwardly back between upper and lower seat portions, whereby a quick connect assembly connects said second sensor mat disposed within the child seat cavity.

15. The motor vehicle dual pressure sensor mat alarm system kit in accordance with claim 11, wherein said alarm audible may be that of a recording of a child crying.

16. The motor vehicle dual pressure sensor mat alarm system kit in accordance with claim 11, further comprising a pushbutton double pole switch associated with said control relay for issuing said alarm.

17. The alarm system kit in accordance with claim 11, further comprising a disengagement switch activated by a driver for deactivating said child sensor seat.

18. The alarm system kit in accordance with claim 17, further comprising a control thermostat operably connected to said alarm buzzer, said thermostat responsive to a temperature sensor achieving a predetermined upper or lower threshold.

19. The alarm system kit in accordance with claim 17, further comprising a timer relay operably connected to said alarm buzzer.
